(19) United States
(12) Patent Application Publication
(10) Pub. No.: US 2026/0094875 A1
(43) Pub. Date: Apr. 2, 2026

(54) SECONDARY BATTERY

(71) Applicant: SK ON CO., LTD., Seoul (KR)

(72) Inventor: Seung Min LEE, Daejeon (KR)

(21) Appl. No.: 19/346,576

(22) Filed: Oct. 1, 2025

(30) Foreign Application Priority Data
Oct. 2, 2024 (KR) 10-2024-0133887

(51) Int. Cl. H01M 10/0585; H01M 10/052; H01M 50/46; H01M 50/586; H01M 50/59

(52) U.S. Cl. CPC H01M 10/0585; H01M 10/052; H01M 50/461; H01M 50/586; H01M 50/59

(57) ABSTRACT

A secondary battery includes an electrode assembly including a separator and electrodes repeatedly stacked with the separator interposed therebetween, and a support structure covering a side surface in a length direction of the electrode assembly and contacting end portions of the separator. Contraction of the separator and short-circuit of the electrodes are prevented by the support structure.

### CROSS-REFERENCE TO RELATED APPLICATION AND CLAIM OF PRIORITY

This application claims priority to Korean Patent Application No. 10-2024-0133887 filed on Oct. 2, 2024 in the Korean Intellectual Property Office (KIPO), the entire disclosure of which is incorporated by reference herein.

### BACKGROUND

### 1. Field

The disclosure of this patent application relates to a secondary battery. More particularly, the disclosure of this patent application relates to a secondary battery including an electrode assembly.

### 2. Descriptions of the Related Art

A secondary battery which can be charged and discharged repeatedly has been widely employed as a power source of a mobile electronic device such as a camcorder, a mobile phone, a laptop computer, etc., according to developments of information communication and display industries. Recently, a battery pack including the secondary battery is being developed and applied as a power source of an eco-friendly vehicle such as an electric automobile.

For example, a secondary battery may include an electrode assembly including a cathode, an anode, and a separation layer (separator), and an electrolyte impregnating the electrode assembly. The secondary battery may further include, e.g., a pouch-shaped outer material accommodating the electrode assembly and the electrolyte.

The cathode and the anode may be alternately and repeatedly stacked with the separator interposed therebetween. The separator may also form a multi-layered structure overlapping each other in a thickness direction.

To implement a high-capacity secondary battery, the number of stacked electrodes in the electrode assembly may be increased. In this case, sufficient adhesion and fixing between the separator and the electrode (the cathode and/or the anode) may not be easily achieved. Additionally, the separator may contract during charging and discharging of the secondary battery to cause an electrode short-circuit.

### SUMMARY

According to an aspect of the present disclosure, there is provided a secondary battery having improved structural stability and mechanical reliability.

A secondary battery according to embodiments of the present disclosure may include an electrode assembly including a separator and electrodes repeatedly stacked with the separator interposed therebetween, and a support structure covering a side surface in a length direction of the electrode assembly and contacting end portions of the separator.

In some embodiments, the support structure may include an adhesive resin material.

In some embodiments, the support structure may include insertion portions inserted into spaces between the end portions of the separator adjacent in a thickness direction, and an extension portion extending in the thickness direction and connecting the insertion portions.

In some embodiments, the insertion portions may be in contact with the electrodes.

In some embodiments, the electrodes may include a cathode and an anode. The insertion portions may be in contact with the anode, and may be spaced apart from the cathode in the length direction.

In some embodiments, a gap space extending in a width direction of the electrode assembly is formed between the insertion portion and the cathode.

In some embodiments, the electrodes may include cathodes and anodes Each of the cathodes may include a cathode tab. Each of the anodes may include an anode tab. The cathode tabs and the anode tabs may protrude through the support structure.

In some embodiments, the support structure may include a first support structure through which the anode tabs extend, and a second support structure through which the cathode tabs extend. The first structure is combined with one end portion of the electrode assembly in the length direction, and the second support structure is combined with the other end portion of the electrode assembly in the length direction.

In some embodiments, the support structure may also cover a side surface of the electrode assembly in a width direction.

A secondary battery may include an electrode assembly including a separator and electrodes repeatedly stacked with the separator interposed therebetween, and a support structure covering a top surface and a bottom surface of the electrode assembly in a thickness direction and contacting end portions of the separator in a length direction of the electrode assembly.

In some embodiments, the top and bottom surfaces of the electrode assembly may be defined by an outermost separator among the separator of the electrode assembly.

In some embodiments, the support structure may contact the top and bottom surfaces of the electrode assembly.

In some embodiments, the support structure may extend in the thickness direction and may commonly contact the end portions of the separator at different levels.

In some embodiments, the support structure may include insertion portions inserted into spaces between the end portions of the separator.

In some embodiments, the electrodes may include electrode tabs protruding in the length direction, and the support structure may extend in a width direction of the electrode assembly between the electrode tabs adjacent to each other.

According to embodiments of the present disclosure, end portions of a separator at each level may be fixed/bonded to each other using a connection structure of an electrode assembly. Accordingly, defects due to non-fixing and shrinkage of the separator around an electrode tab may be prevented. Additionally, an electrode short-circuit due to defects in the separator may be prevented, and operation stability of the secondary battery may be enhanced.

The secondary battery of the present disclosure may be widely applied in green technology fields such as an electric vehicle, a battery charging station, a solar power generation, a wind power generation, etc., using a battery, etc. The lithium secondary battery according to the present disclosure may be used for eco-friendly electric vehicles and hybrid vehicles to prevent a climate change by suppressing air pollution and greenhouse gas emissions, etc.

### BRIEF DESCRIPTION OF THE DRAWINGS

FIG. 1 is a schematic perspective view illustrating a secondary battery according to embodiments.

FIG. 2 and FIG. 3 are schematic cross-sectional views illustrating a secondary battery according to embodiments.

FIG. 4 is a schematic cross-sectional view illustrating a secondary battery according to some embodiments.

### DETAILED DESCRIPTION OF THE EMBODIMENTS

Hereinafter, the present disclosure will be described in detail with reference to example embodiments. However, these are merely illustrative and the present disclosure is not limited to the specific embodiments provided herein.

The terms such as “first”, “second”, “bottom”, “below”, “lower”, “top”, “upper”, “above,” etc., are used in a relative sense to distinguish different elements or positions, and do not specify an absolute position or an absolute order.

In the accompanying drawings, the first direction and the second direction may be parallel to a top surface or a bottom surface of an electrode assembly, and may be perpendicular to each other. The first direction and the second direction may be a length direction and a width direction, respectively, of an electrode of a secondary battery. The first direction may be a direction in which an electrode tab protrudes.

A third direction may be a direction perpendicular to the first direction and the second direction. The third direction may be a thickness direction of the secondary battery or the electrode assembly.

The top surface and the bottom surface of the electrode assembly may correspond to a main surface having the largest area among outer surfaces of the electrode assembly. The top surface and the bottom surface may be surfaces facing each other in the third direction.

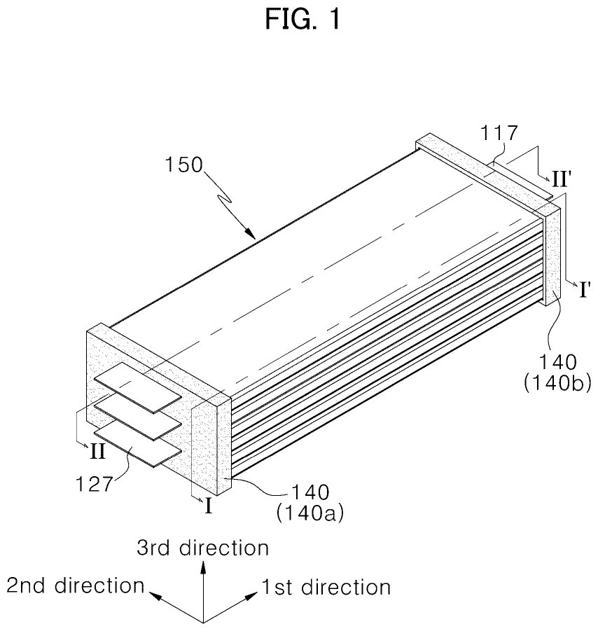

FIG. 1 is a schematic perspective view illustrating a secondary battery according to embodiments. For convenience of descriptions, illustration of a case is omitted in FIG. 1, and illustration of detailed structures of the electrode assembly 150 is omitted. In FIG. 1, three electrode tabs (anode tabs 127) protruding from one end portion of the electrode assembly in the first direction are illustrated, but the number of the electrode tabs is not limited thereto, and may be further increased.

Referring to FIG. 1, the secondary battery according to embodiments of the present disclosure may include an electrode assembly 150 and a support structure 140. The electrode assembly 150 may include electrodes that are repeatedly stacked in the third direction with a separator interposed therebetween. Electrode tabs 117 and 127 may be formed at an end portion (an end portion in the first direction) of the electrode assembly 150. The electrode tabs 117 and 127 may protrude from the end portion of the electrode assembly 150 in the first direction.

The electrode tabs 117 and 127 may include cathode tabs 117 and anode tabs 127. In some embodiments, the anode tabs 127 may protrude from one end portion of the electrode assembly 150 in the first direction, and the cathode tabs 117 may protrude from the other end portions of the electrode assembly 150 in the first direction.

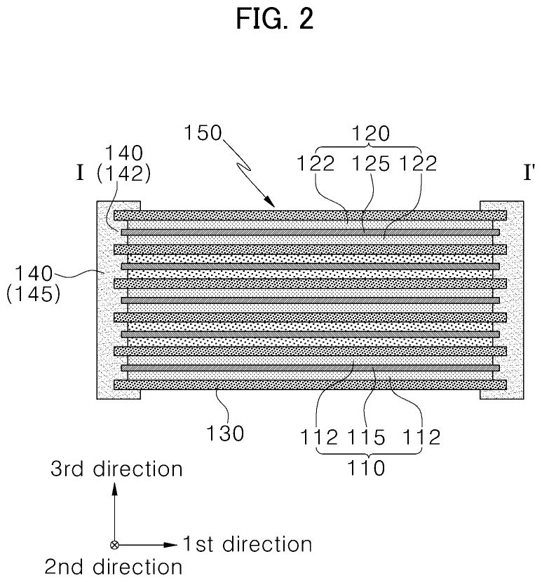

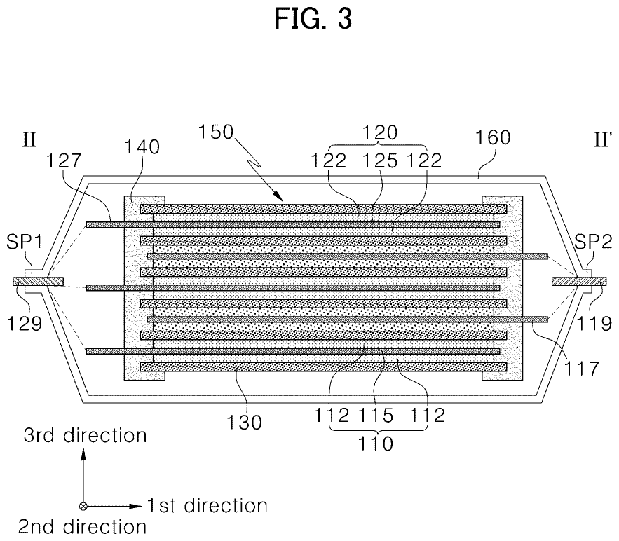

Elements and structures of the electrode assembly 150 will be described in more detail with reference to FIGS. 2 and 3.

The support structure 140 may be coupled to the end portions of the electrode assembly 150. As described above, when the anode tabs 127 and the cathode tabs 117 are disposed at the one end portion and the other end portion, respectively, the support structure 140 may include a first support structure 140a coupled to the one end portion and a second support structure 140b coupled to the other end portion.

The support structure 140 may also be formed between the electrode tabs 117 and 127. The support structure 140 may include a portion extending in the second direction between neighboring electrode tabs 117 and 127.

According to embodiments, the electrode tabs 117 and 127 may penetrate the support structure 140 and protrude in the first direction. The anode tabs 127 may penetrate the first support structure 140a, and the cathode tabs 117 may penetrate the second support structure 140b.

The support structure 140 may cover side surfaces of the electrode assembly 150 in the first direction. In some embodiments, the support structure 140 may partially cover the top and bottom surfaces of the electrode assembly 150 in the third direction.

In some embodiments, the support structure 140 may also cover side surfaces of the electrode assembly 150 in the second direction.

In an embodiment, the support structure 140 may have a cap shape covering the end portion of the electrode assembly 150 in the first direction so that the electrode tabs 117 and 127 may extend through the support structure 140.

FIGS. 2 and 3 are schematic cross-sectional views illustrating a secondary battery according to embodiments. FIG. 2 is a cross-sectional view taken along a line I-I′ of FIG. 1 in the third direction. FIG. 3 is a cross-sectional view taken along a line II-II′ of FIG. 1 in the third direction. In FIG. 3, a case 160 and electrode leads 119 and 129 of the secondary battery are illustrated.

Referring to FIGS. 2 and 3, the electrode assembly 150 may include electrodes including a cathode 110 and an anode 120, and a separator 130.

The cathode 110 may include a cathode current collector 115 and a cathode active material layer 112 formed on the cathode current collector 115. The cathode active material layer 112 may be formed on a top surface or a bottom surface of the cathode current collector 115. In an embodiment, the cathode active material layer 112 may be formed on each of the top surface and the bottom surface of the cathode current collector 115.

The cathode current collector 115 may include stainless steel, nickel, aluminum, titanium, or an alloy thereof. In some embodiments, the cathode current collector 115 may include aluminum.

The cathode active material layer 112 may include a cathode active material and a binder. The cathode active material may include a lithium-containing cathode active material. The lithium-containing cathode active material may include a lithium-nickel oxide, a lithium-cobalt-manganese oxide, a lithium-nickel-cobalt-manganese oxide, a lithium-nickel-aluminum-based oxide, a lithium-cobalt-aluminum-based oxide, or the like.

The binder may include polyvinylidene fluoride (PVDF), vinylidene fluoride-hexafluoropropylene copolymer, polyacrylonitrile, polymethyl methacrylate, acrylonitrile-butadiene rubber (NBR), polybutadiene rubber (BR), styrene-butadiene rubber (SBR), a polyacrylic acid-based binder, poly(3,4-ethylenedioxythiophene), (PEDOT)-based binder, or the like. In some embodiments, a PVDF-based binder may be used as the cathode binder.

The anode 120 may include an anode current collector 125 and an anode active material layer 122 formed on the anode current collector 125. The anode active material layer 122 may be formed on a top surface or a bottom surface of the anode current collector 125. In an embodiment, the anode active material layer 122 may be formed on each of the top surface and the bottom surface of the anode current collector 125.

The anode current collector 125 may include a copper foil, a nickel foil, a stainless steel foil, a titanium foil, a nickel foam, a copper foam, a polymer substrate coated with a conductive metal, or the like. In an embodiment, the anode current collector 125 may include copper.

The anode active material layer 122 may include an anode active material and a binder. The anode active material may include a carbon-based active material such as natural graphite and artificial graphite, and/or a silicon-containing active material (e.g., SiOx (0<x<2)). The anode active material may include a silicon-carbon composite material.

The binder may contain the above-described material. In some embodiments, a styrene-butadiene rubber (SBR)-based binder, carboxymethyl cellulose (CMC), a polyacrylic acid-based binder, poly(3,4-ethylenedioxythiophene) (PEDOT)-based binder, etc., may be used as the anode binder.

For example, each of the cathode current collector 115 and the anode current collector 125 may have a thickness of 5 μm to 50 μm. In an embodiment, the cathode current collector 115 and the anode current collector 125 may have a thickness from 5 μm to 40 μm, from 5 μm to 30 μm, from 5 μm to 20 μm, or from 5 μm to 10 μm.

The cathode active material layer 112 and the anode active material layer 122 may further include a conductive material, a thickener, or the like. The conductive material may be added to enhance conductivity and/or mobility of lithium ions or electrons.

For example, the conductive material may include a carbon-based conductive material such as graphite, carbon black, acetylene black, Ketjen black, graphene, a carbon nanotube, a vapor-grown carbon fiber (VGCF), a carbon fiber, etc., and/or a metal-based conductive material such as tin, tin oxide, titanium oxide, a perovskite material including LaSrCoO₃ and LaSrMnO₃, etc. The thickener may include a cellulose-based material such as carboxymethyl cellulose (CMC).

The separator 130 may be interposed between the cathode 110 and the anode 120. For example, the separator 130 may include a porous polymer film or a porous non-woven fabric.

The porous polymer film may include a polyolefin-based polymer such as an ethylene polymer, a propylene polymer, an ethylene/butene copolymer, an ethylene/hexene copolymer, an ethylene/methacrylate copolymer, or the like.

The porous non-woven fabric may include a high melting point glass fiber, a polyethylene terephthalate fiber, or the like.

The separator 140 may include a ceramic-based material. For example, inorganic particles may be coated on the polymer film or dispersed in the polymer film to improve a heat resistance.

The electrode assembly 150 may be formed as a winding type, a stacking type, a zigzag folding type, or a stack-folding type.

In an embodiment, the cathode 110 and the anode 120 may be inserted into each space formed by folding the separator 130 in a zigzag shape.

In an embodiment, multiple separators 130 may be separated from each other and repeatedly stacked with the electrodes 110 and 120 interposed therebetween in the third direction.

An area of the separator 130 (an area in a plan view observed in the third direction) may be greater than an area of each of the cathode 110 and the anode 120. For example, the area of the separator 130 may be greater than an area of each of the cathode 110 and the anode 120 excluding the electrode tabs 117 and 127.

Accordingly, end portions of the separator 130 may protrude in the first direction, and the separator 130 may entirely cover the cathode 110 and the anode 120 except for the electrode tabs 117 and 127 in the third direction.

As described with reference to FIG. 1, the support structure 140 may be disposed on the end portion of the electrode assembly 150 in the first direction. The support structure 140 may extend in the third direction, and may be attached to end portions of the separator 130 exposed at a plurality of levels or layers.

According to embodiments, the support structure 140 may be in direct contact with the end portions of the separator 130. The support structure 140 may extend in the third direction to connect the end portions of the separator 130 to each other.

The support structure 140 may include an insertion portion 142 and an extension portion 145. The insertion portion 142 may be inserted into a space between the electrodes 110 and 120 and the end portions of the separator 130 adjacent to each other in the third direction. A plurality of the insertion portions 142 may be arranged along the third direction and may fill the space of each level or each layer.

The insertion portions 142 may be in direct contact with or attached to the end portions of the separator 130. The extension portion 145 may extend in the third direction and integrally connect the insertion portions 142 to each other.

The insertion portions 142 may also be in contact with end portions of the electrodes 110 and 120. In some embodiments, the insertion portions 142 may be in contact with each end portion of the cathode 110 and an end portion of the anode 120.

An upper portion and a lower portion of the support structure 140 may be in contact with a top surface and a bottom surface of the electrode assembly 150, respectively. The top surface and the bottom surface of the electrode assembly 150 may be defined by portions of the separator 130 exposed to an outside of the electrode assembly 150. Accordingly, the upper and lower portions of the support structure 140 may be in contact with or attached to portions of the separator 130 exposed to the outside.

The support structure 140 may include an adhesive material. For example, a composition including an adhesive resin such as an acrylic resin, a siloxane resin, a silicone resin, an epoxy resin, etc., may be applied on the end portion of the electrode assembly 150 to sufficiently fill the spaces between the end portions of the separator 140, and then cured to form the support structure 140.

As illustrated in FIG. 3, the electrode assembly 150 may be accommodated in the case 160 together with an electrolyte solution to define a secondary battery. According to embodiments, a non-aqueous electrolyte solution may be used as the electrolyte solution.

The non-aqueous electrolyte solution may include a lithium salt as an electrolyte and an organic solvent. The lithium salt may be expressed as, e.g., Li⁺X⁻, and examples of an anion (X⁻) of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N; CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, or the like.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dimethyl sulfoxide, acetonitrile, dimethoxyethane, diethoxyethane, vinylene carbonate, sulfolane, gamma-butyrolactone, propylene sulfite, tetrahydrofuran, or the like. These may be used alone or in a combination of two or more therefrom.

As indicated by dotted lines in FIG. 3, the electrode tabs 117 and 127 may extend to one end portion and the other end portion of the case 160 in the first direction to be merged with each other.

The anode tabs 127 may be merged by terminal end portions thereof, and may be welded with an anode lead 129 together with the one end portion of the case 160. A first sealing portion SP1 may be formed at the one end portion of the case 160 by the welding, and the anode lead 129 may protrude from the first sealing portion SP1 to an outside of the case 160.

The cathode tabs 117 may be merged by terminal end portions thereof, and may be welded with a cathode lead 119 together with the other end portion of the case 160. A second sealing portion SP2 may be formed at the other end portion of the case 160 by the welding, and the cathode lead 119 may protrude from the second sealing portion SP2 to the outside of the case 160.

FIGS. 1 to 3 illustrate that the cathode lead 119 and the anode lead 129 are formed at the one end portion and the other end portion, respectively, in the first direction. However, the cathode lead 119 and the anode lead 129 may be formed at the same end portion. In this case, the cathode tabs 117 and the anode tabs 127 may penetrate the support structure 140 together at the same end portion.

As illustrated in FIG. 3, the secondary battery may be prepared in a pouch type. In some embodiments, the secondary battery may be prepared in a cylindrical shape using a can, a prismatic shape, or a coin shape.

According to the above-described embodiments of the present disclosure, the separator 130 may be fixed by the support structure 140 at the end portion of the electrode assembly 150. The separator 130 may include a polymer material, as described above, and may be easily contracted by heat caused by repetition of charging/discharging. Further, the cathode 110 and the anode 120 may be physically inserted into the space between the separators 130, and may not be stably fixed by the separator 130.

Accordingly, when the separator 130 is contracted, end portions of the cathode 110 and the anode 120 may be short-circuited, and thermal and mechanical stability of the battery cell or the secondary battery may be deteriorated.

However, according to embodiments of the present disclosure, the support structure 140 may be attached to the end portions of the separator 130 to prevent the contraction of the separator 130. Additionally, even when the separator 130 is contracted, the support structure 140 may fill the space between the separator 130 and the electrodes 110 and 120, and may suppress or block the short-circuit of the electrodes 110 and 120.

Further, the support structure 140 may have a structure in which the insertion portions 142 of each level are integrally connected through the extension portion 145. Thus, the shrinkage or contraction of the separator 130 may be uniformly suppressed in all levels or all layers.

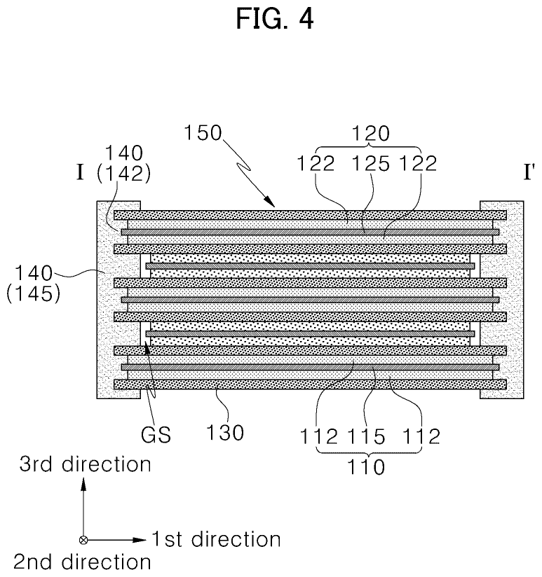

FIG. 4 is a schematic cross-sectional view illustrating a secondary battery according to some embodiments. Detailed descriptions on elements and structures substantially the same as or similar to those described with reference to FIGS. 1 to 3 are omitted.

Referring to FIG. 4, a contact area of the cathode 110 with the separator 130 may be smaller than a contact area of the anode 120 with the separator 130. Accordingly, a region of the anode 120 in which the lithium ions generated from the cathode 110 may be accepted and reacted may be sufficiently achieved.

According to embodiments of FIG. 4, the support structure 140 may contact the end portions of the separator 130 and the anode 120, and may not contact the end portion of the cathode 110. Accordingly, the insertion portion 142 of the support structure 140 and the cathode 110 may be spaced apart from each other in the first direction.

Thus, a gap space GS may be formed between the insertion portion 142 of the support structure 140 and the cathode 110. The gap space GS may be formed at each level of the electrode assembly 150 in which the cathode 110 is disposed, and may extend in the second direction.

According to the above-described embodiments, the support structure 140 may be in contact with or attached to the separator 130 and the anode 120, and may provide stability with respect to expansion/contraction of the electrode assembly 150. Further, capacity and rate properties may be enhanced by obtaining movement/impregnation space of the electrolyte solution through the gap space GS formed between the support structure 140 and the cathode 110.

The secondary battery according to the above-described embodiments of the present disclosure may be provided as a unit battery cell. A plurality of the unit battery cells may be combined to obtain a battery assembly in the form of a module or a pack. For example, the cathode leads 119 included in the plurality of unit battery cells may be connected to each other to form a cathode terminal of the module or the pack, and the anode leads 129 may be connected to each other to form an anode terminal of the module or pack.

What is claimed is:

1. A secondary battery, comprising:
an electrode assembly comprising a separator and electrodes repeatedly stacked with the separator interposed therebetween; and
a support structure covering a side surface in a length direction of the electrode assembly and contacting end portions of the separator.

2. The secondary battery of claim 1, wherein the support structure includes an adhesive resin material.

3. The secondary battery of claim 1, wherein the support structure comprises insertion portions inserted into spaces between the end portions of the separator adjacent in a thickness direction, and an extension portion extending in the thickness direction and connecting the insertion portions.

4. The secondary battery of claim 3, wherein the insertion portions are in contact with the electrodes.

5. The secondary battery of claim 3, wherein the electrodes comprise a cathode and an anode,
the insertion portions are in contact with the anode and are spaced apart from the cathode in the length direction.

6. The secondary battery of claim 5, wherein a gap space extending in a width direction of the electrode assembly is formed between the insertion portion and the cathode.

7. The secondary battery of claim 1, wherein the electrodes comprise cathodes and anodes,
each of the cathodes comprises a cathode tab, and each of the anodes comprises an anode tab, and
the cathode tabs and the anode tabs protrude through the support structure.

8. The secondary battery of claim 7, wherein the support structure comprises:
a first support structure through which the anode tabs extend, the first structure being combined with one end portion of the electrode assembly in the length direction; and
a second support structure through which the cathode tabs extend, the second support structure being combined with the other end portion of the electrode assembly in the length direction.

9. The secondary battery of claim 1, wherein the support structure also covers a side surface of the electrode assembly in a width direction.

10. A secondary battery, comprising:
an electrode assembly comprising a separator and electrodes repeatedly stacked with the separator interposed therebetween; and
a support structure covering a top surface and a bottom surface of the electrode assembly in a thickness direction and contacting end portions of the separator in a length direction of the electrode assembly.

11. The secondary battery of claim 10, wherein the top and bottom surfaces of the electrode assembly are defined by an outermost separator among the separator of the electrode assembly.

12. The secondary battery of claim 11, wherein the support structure contacts the top and bottom surfaces of the electrode assembly.

13. The secondary battery of claim 10, wherein the support structure extends in the thickness direction and commonly contacts the end portions of the separator at different levels.

14. The secondary battery of claim 10, wherein the support structure comprises insertion portions inserted into spaces between the end portions of the separator.

15. The secondary battery of claim 10, wherein the electrodes comprise electrode tabs protruding in the length direction, and
the support structure extends in a width direction of the electrode assembly between the electrode tabs adjacent to each other.
